(19) United States
(12) Patent Application Publication
(10) Pub. No.: US 2004/0050047 A1
(43) Pub. Date: Mar. 18, 2004

(54) Low speed turbo EGR

(76) Inventor: Steven Don Arnold, Rancho Palos Verdes, CA (US)

Correspondence Address: Ephraim Starr, Division General Counsel, Honeywell International Inc., 23326 Hawthorne Boulevard, Suite #200, Torrance, CA, 90505, US

(21) Appl. No.: 10/647,046

(22) Filed: Aug. 21, 2003

Related U.S. Application Data
(60) Provisional application No. 60/404,975, filed on Aug. 21, 2002.

(51) Int. Cl. F02B 33/44; F02M 25/07

(52) U.S. Cl. 60/605.2; 60/602; 123/568.17

(57) ABSTRACT

An Exhaust Gas Recirculation (EGR) system for an internal combustion engine is provided. The EGR system utilizes a turbocharger having a compressor with more than one stage. The first stage of the compressor boosts the intake air to an intermediate pressure below the pressure at the intake manifold of the engine. The recirculated exhaust gas is maintained at approximately this intermediate pressure, thus providing a lower back pressure on the exhaust manifold of the engine, thereby improving fuel efficiency. The exhaust gas and intake air are mixed and subsequently boosted by a second stage of the compressor to a pressure required to supply the demanded mass flow to the engine.

### CROSS-REFERENCE TO RELATED APPLICATIONS

This application claims the benefit of the filing of U.S. Provisional Patent Application Serial No. 60/404,975, entitled “Low speed turbo/EGR”, filed on Aug. 21, 2002, and the specification thereof is incorporated herein by reference.

### BACKGROUND OF THE INVENTION

1. Field of the Invention (Technical Field)

The present invention relates to the field of internal combustion engine exhaust gas recirculation (EGR) for emissions improvement and increased operating efficiency, including increased fuel economy. More particularly, the invention provides a system and method for a new type of intermediate pressure EGR loop that is enabled by a two stage compressor.

2. Description of Related Art

EGR is a known method for reducing the NOX emissions in internal combustion engines. For effective use, an EGR system must overcome the adverse pressure gradient created by a positive pressure gradient across the engine which is typical of modern high efficiency diesel engines in at least a portion of their operating range. Various approaches to implementing EGR have included pumping of a portion of the exhaust gas from the exhaust manifold to the intake manifold. Pumping has been accomplished by introducing the exhaust gas into the compression inlet of a conventional turbocharger or supercharger present on the engine or, alternatively, providing a separate compressor receiving the exhaust gas and pressurizing it to a suitable pressure for insertion into the charge air downstream of the charge air boosting system on the engine. Some fuel consumption penalty is generally incurred by these systems.

EGR also requires adequate mixing of recirculated exhaust gas with the incoming intake air charge to avoid performance degradation and to minimize mixing losses to avoid additional fuel consumption penalties. Further, positive control of the recirculated exhaust gas flow is required to assure proper proportions in the charge air mixture supplied to the engine intake manifold under varying operating conditions. Additionally, the components and features of an EGR system must be accommodated within the constraints of limited volume available for allocation in modern engine compartments.

Low pressure loop EGR typically takes exhaust gas from the exhaust manifold, downstream of particulate traps and other emission control devices, and injects the exhaust gas into the compressor. The resulting compressed gas, typically mixed with intake air, is delivered to the intake manifold of the engine. Low pressure loop EGR works well at low power or load settings, reducing the fuel economy penalty that a high pressure loop would incur at low loads, and allowing very high EGR rates to be achieved. However, at high power or load settings low pressure loop EGR incurs a very large fuel penalty due to the need for flow ranges outside the capabilities of turbine-driven compressors, a poor turbine-to-compressor flow match and excessive heat loads, as well as the increase in back pressure caused by the need to boost the EGR exhaust gas to a pressure greater than that of the intake manifold. Multiple single stage turbochargers are not preferred as a solution because of the added cost and space and reliability requirements necessary to achieve high compression ratios.

Similarly, high pressure loop EGR works best at moderate to high loads, minimizing the boost pressure required. However, at low loads, high pressure loop EGR systems suffer from a large reduction in fuel economy due to the negative pressure differential required to drive the required high EGR rates.

### BRIEF SUMMARY OF THE INVENTION

The invention provides an intermediate pressure EGR system for an internal combustion engine, preferably a diesel engine, comprising a turbocharger including a compressor having more than one stage, and preferably having two stages. Unlike traditional high or low pressure EGR systems, the present invention provides increased fuel economy under all load conditions. A control valve determines the proportion of exhaust gas to be recirculated, and helps to control the pressure of the exhaust gas. The remainder of the exhaust gas turns the turbine of the turbocharger and is discharged to the environment. The turbine is optionally a variable geometry turbine. The discharge gas optionally flows through one or more emissions control devices. The exhaust turbine pressure ratio maintains the EGR flow at the turbine inlet pressure, which is less than the pressure at the intake manifold of the engine. The recirculated exhaust gas preferably flows through a diesel particulate filter and is optionally cooled by an EGR cooler. The diesel particulate filter is optionally a miniature diesel particulate filter. The first stage of the compressor boosts the intake air to an intermediate pressure. The compressed intake air is optionally cooled by an air/air charge cooler. The intake air and exhaust gas to be recirculated are then mixed, preferably by an EGR mixer. The mixture is optionally cooled by an Air/EGR cooler, then injected into the second stage of the two stage compressor, which boosts the mixture pressure to a level sufficient to satisfy the mass flow demand of the engine. The mixture is cooled with an air/air charge cooler before entering the intake manifold.

The invention also provides an EGR system wherein a turbocharger maintains a pressure of exhaust gas at an intermediate pressure lower than the pressure at the intake manifold, thereby improving the fuel economy over other low or high pressure EGR systems. The exhaust gas pressure is greater than the pressure of intake air, which has been compressed by the first stage of a two stage compressor. The exhaust gas to be recirculated is mixed with the intake air and the mixture is compressed by the second stage of the compressor to a pressure required to provide the desired mass flow to the engine.

The invention further provides a method of providing exhaust gas recirculation to an internal combustion engine, comprising the steps of maintaining the exhaust gas at an intermediate pressure less than the pressure at the intake manifold, optionally filtering the exhaust gas, optionally cooling the exhaust gas, using the first stage of a multiple stage compressor to increase the pressure of intake air to a pressure less than the intermediate pressure of the exhaust gas, mixing the exhaust gas and intake air, and boosting the pressure of the mixture to a pressure sufficient to meet the mass flow demand of the engine. Maintaining the pressure of the exhaust gas is preferably accomplished by using back pressure from a turbocharger turbine. The pressure of the mixture is preferably boosted by a secondary stage of the compressor.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a schematic diagram of an engine and EGR system employing the components of the present invention; and

FIG. 2 is a schematic diagram of an alternative embodiment of the present invention.

### DETAILED DESCRIPTION OF THE INVENTION

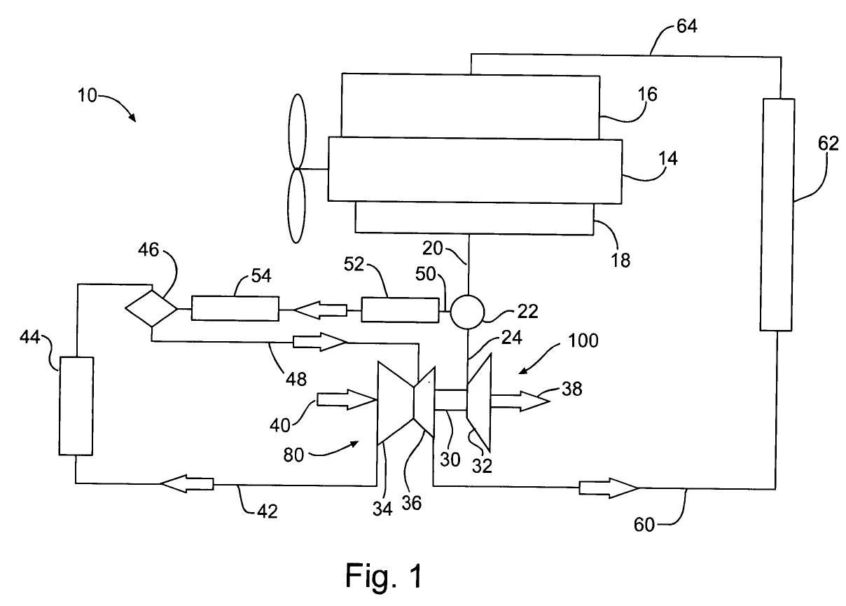

Referring to the drawings, FIG. 1 shows an internal combustion engine system 10 including the intermediate pressure loop EGR system of this invention. Internal combustion engine 14 has at least one cylinder in communication with exhaust manifold 18 and intake manifold 16. Exhaust manifold 18 is connected to exhaust line 20 which in turn is connected to control valve 22, which controls the relative amount of exhaust gas entering either the intermediate pressure EGR loop line 50 or the exhaust turbine line 24. Control valve 22 also partially controls the pressure within the EGR line. Exhaust gas not diverted to intermediate pressure EGR loop line 50 by control valve 22 is directed by means of exhaust turbine inlet line 24 to exhaust turbine 32. Exhaust gas entering exhaust turbine 32 produces rotational energy, thereby driving two-stage compressor 80 which comprises first stage 34 and second stage 36. Exhaust gas exits turbine 32 by means of exhaust line 38 and is discharged into the atmosphere, optionally through various emission control devices (not pictured), including but not limited to a catalytic converter, a diesel oxidation catalyst (DOC), a lean NOX trap (LNT), and/or a diesel particulate filter (DPF).

Turbocharger 100, which comprises two stage compressor 80, connecting shaft 30, and exhaust turbine 32, is optionally a variable geometry turbocharger. In one embodiment of a variable geometry turbocharger the vanes of exhaust turbine 32 are actuated by an actuator, such as a hydraulic actuator, so that the efficiency or operational flow range of exhaust turbine 32 can be varied during operation, thereby providing for optimal system efficiency and mass flow control. A variable geometry turbocharger provides for increased system efficiencies not readily obtainable with standard turbochargers. A variable geometry turbocharger is disclosed in commonly owned U.S. Pat. No. 6,269,642, issued Aug. 7, 2001, and incorporated herein by reference. However, it is to be understood that the invention is not limited to the variable geometry turbocharger of U.S. Pat. No. 6,269,642, and that other variable geometry turbochargers may be employed, and further that turbochargers not providing for variable geometry may be employed.

Exhaust gas in intermediate pressure EGR loop line 50 is maintained by exhaust turbine 32 at an intermediate pressure less than the pressure at the intake manifold 16 of engine 14. Exhaust gas diverted to intermediate pressure EGR loop line 50 passes through DPF 52, which DPF 52 is optionally miniature in size, and is cooled by EGR cooler 54. Intake air enters first stage 34 at air intake 40, is compressed by first stage 34 to an intermediate pressure less than the pressure at the intake manifold, exits through air line 42, and is cooled by air/air charge cooler 44. The exhaust gas pressure in intermediate pressure EGR loop line 50 is sufficiently higher than the discharge pressure of the first stage 34 to eliminate the need for creating a negative pressure gradient to enable the EGR to flow in the correct direction. However, that exhaust gas pressure is less than the pressure at intake manifold 64.

The cooled intake air and exhaust gas are mixed together by EGR mixer 46 to form an Air/EGR mixture. The pressures within loop line 50 and air line 42 are each at an intermediate pressure lower than that at intake manifold 16, with the pressures being matched by control valve 22. Thus, the back pressure at the exhaust manifold 18 is lower than it would be if the exhaust gas had been restricted, raising it above the pressure at intake manifold 16, thus thereby reducing the work required to be done by engine 14. The lower back pressure and reduced work improve fuel economy greatly over known low or high pressure EGR systems.

The Air/EGR mixture exit EGR mixer 46 by means of second stage inlet line 48 and enters second stage 36 of compressor 80. Second stage 36 compresses the Air/EGR mixture to a pressure required by the engine to transit the desired mass flow. The Air/EGR mixture is cooled by air/air charge cooler 62 and proceeds through intake line 64 to enter intake manifold 16.

Commonly owned U.S. Pat. No. 6,062,028, issued May 16, 2000, incorporated herein by reference, discloses a low speed, high compression ratio turbocharger with minimal packaging size comprising a two stage compressor. However, it is to be understood that the invention is not limited to the turbocharger of U.S. Pat. No. 6,062,028, and that other two stage compressor turbochargers, or turbochargers with more than two stages, may be employed.

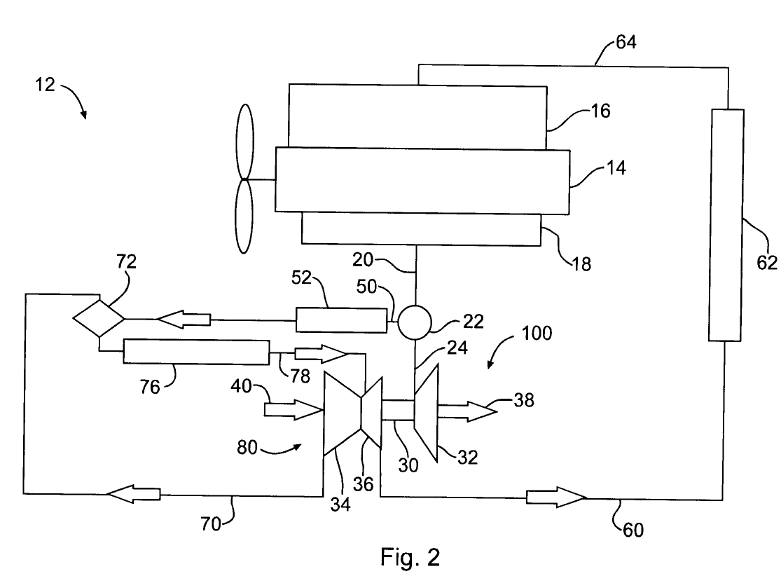

FIG. 2 shows an internal combustion engine system 12 including an alternative embodiment of the low pressure loop EGR system of this invention. This embodiment is identical to the embodiment depicted in FIG. 1, except that exhaust gas exiting DPF 52 proceeds directly to high temperature EGR mixer 72 without first being cooled. Similarly, intake air compressed by first stage 34 of compressor 80 passes through air line 70 directly to high temperature EGR mixer 72 without first being cooled. After the compressed intake air and exhaust gas are mixed together by high temperature EGR mixer 72 to form an Air/EGR mixture, the mixture is then cooled by Air/EGR cooler 76 and proceeds along second stage inlet line 78 and enters second stage 36 of compressor 80 as described above.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An Exhaust Gas Recirculation (EGR) system providing a mixture of exhaust gas and intake air to the intake of an internal combustion engine, the system comprising a turbocharger including a compressor with more than one stage.

2. The EGR system of claim 1 wherein intake air is compressed in at least one first stage of the compressor, and a mixture of intake air and exhaust gas is compressed in at least one second stage of the compressor.

3. The EGR system of claim 2 wherein the compressor has two stages.

4. The EGR system of claim 2 wherein the turbocharger is a variable geometry turbocharger.

5. The EGR system of claim 2 further comprising a control valve which determines the proportion of exhaust gas produced by the engine to be recirculated.

6. The EGR system of claim 2 further comprising an EGR mixer to mix the exhaust gas with intake air to form the mixture.

7. The EGR system of claim 6 wherein the intake air is compressed by at least one first stage of the turbocharger to achieve a first intermediate pressure, the first intermediate pressure being less than an intake pressure at an intake manifold of the engine, and wherein back pressure from a turbocharger turbine maintains a pressure of the exhaust gas at a second intermediate pressure, the second intermediate pressure being less than an intake pressure at an intake manifold of the engine.

8. The EGR system of claim 1 wherein the turbocharger comprises:
a case having a turbine housing receiving exhaust gas from an exhaust manifold of an internal combustion engine at an inlet and having an exhaust outlet, a compressor housing having an air inlet and a first volute, and a center housing intermediate the turbine housing and compressor housing;
a turbine wheel carried within the turbine housing and extracting energy from the exhaust gas, said turbine wheel connected to a shaft extending from the turbine housing through a shaft bore in the center housing;
a bearing supported in the shaft bore of the center housing, said bearing supporting the shaft for rotational motion;
a compressor impeller connected to the shaft opposite the turbine wheel and carried within the compressor housing, said compressor impeller having a first plurality of impeller blades mounted on a front face proximate the air inlet, said first plurality of blades increasing the velocity of air from the air inlet and exhausting air into the first volute, said compressor impeller also having a second plurality of impeller blades mounted on a back face, said second plurality of blades increasing the velocity of air from a scroll inlet connected to the first volute, and exhausting air into a second volute having a charge air outlet connected to the engine intake, said scroll inlet and second volute integral to the case intermediate said compressor housing and turbine housing.

9. The EGR system of claim 8 wherein the second plurality of impeller blades compresses the mixture to a pressure required by the engine to transit a desired mass flow.

10. The EGR system of claim 9 further comprising a diesel particulate filter to filter the exhaust gas before the exhaust gas enters the first plurality of blades.

11. The EGR system of claim 2 further comprising at least one cooler.

12. The EGR system of claim 2 further comprising at least one emissions control device.

13. An EGR system for an internal combustion engine wherein a turbocharger maintains a pressure of exhaust gas at an intermediate pressure lower than a pressure at an intake manifold of the engine, wherein said intermediate pressure is greater than a pressure of intake air, the intake air having been compressed by a first stage of a two stage compressor.

14. The EGR system of claim 13 wherein the compressor forms a part of a turbocharger.

15. The EGR system of claim 14 wherein the exhaust gas and the intake air are mixed together to form a mixture, and the mixture is further compressed by a second stage of the two stage compressor until the mixture reaches a pressure sufficient to meet a mass flow demand of the engine.

16. A method of providing exhaust gas recirculation to an internal combustion engine comprising the steps of:
maintaining a pressure of exhaust gas produced by the engine at a first intermediate pressure less than a pressure at an intake manifold of the engine;
increasing a pressure of intake air to a second intermediate pressure;
mixing the exhaust gas and intake air to form a mixture; and
boosting the pressure of the mixture to a pressure sufficient to meet a mass flow demand of the engine.

17. The method of claim 16 wherein the maintaining step comprises using back pressure from a turbocharger turbine.

18. The method of claim 16 wherein the maintaining step further comprises filtering the exhaust gas.

19. The method of claim 16 wherein the increasing step comprises compressing the intake air with a first stage of a two stage compressor.

20. The method of claim 16 wherein the boosting step comprises compressing the mixture using the second stage of a two stage compressor of a turbocharger, wherein the turbocharger comprises:
a case having a turbine housing receiving exhaust gas from an exhaust manifold of an internal combustion engine at an inlet and having an exhaust outlet, a compressor housing having an air inlet and a first volute, and a center housing intermediate the turbine housing and compressor housing;
a turbine wheel carried within the turbine housing and extracting energy from the exhaust gas, said turbine wheel connected to a shaft extending from the turbine housing through a shaft bore in the center housing;
a bearing supported in the shaft bore of the center housing, said bearing supporting the shaft for rotational motion;
a compressor impeller connected to the shaft opposite the turbine wheel and carried within the compressor housing, said compressor impeller having a first plurality of impeller blades mounted on a front face proximate the air inlet, said first plurality of blades increasing the velocity of air from the air inlet and exhausting air into the first volute, said compressor impeller also having a second plurality of impeller blades mounted on a back face, said second plurality of blades increasing the velocity of air from a scroll inlet connected to the first volute, and exhausting air into a second volute having a charge air outlet connected to the engine intake, said scroll inlet and second volute integral to the case intermediate said compressor housing and turbine housing.
